(19) United States
(12) Patent Application Publication
(10) Pub. No.: US 2006/0250463 A1
(43) Pub. Date: Nov. 9, 2006

(54) Recording method, set of ink compositions applicable to recording method and image-forming apparatus

(75) Inventors: Ikuo Nakazawa, Kanagawa-ken (JP); Koichi Sato, Tokyo (JP); Ryuji Higashi, Tokyo (JP); Sakae Suda, Tokyo (JP); Masayuki Ikegami, Tokyo (JP); Keiichiro Tsubaki, Tokyo (JP); Keiko Yamagishi, Tokyo (JP)

Correspondence Address: FITZPATRICK CELLA HARPER & SCINTO, 30 ROCKEFELLER PLAZA, NEW YORK, NY, 10112, US

(73) Assignee: Canon Kagushiki Kaisha, Tokyo (JP)

(21) Appl. No.: 10/549,109

(22) PCT Filed: May 2, 2005
(86) PCT No.: PCT/JP05/08654

§ 371 Date: Sep. 14, 2005

(30) Foreign Application Priority Data
May 7, 2004 (JP) 2004-139194
Dec. 27, 2004 (JP) 2004-376606

(51) Int. Cl. G01D 11/00

(52) U.S. Cl. 347/100

(57) ABSTRACT

A recording method includes the steps of: preparing a first ink composition containing a solvent, a coloring material and an anionic polymer, in which the coloring material is incorporated in the anionic polymer, and a second ink composition containing a solvent, a coloring material and a cationic polymer; and applying the first ink composition and the second ink composition onto a medium by bringing the compositions into contact with each other. The contact increases the viscosity of at least one of the anionic polymer and the cationic polymer.

### TECHNICAL FILED

The present invention relates to a recording method, a set of ink compositions applicable to the recording method and an image-forming apparatus. More particularly, the present invention relates to a recording method suitable for recording with the use of an ink jet method.

### BACKGROUND ART

In recent years, a digital printing technology has been progressing by leaps and bounds. The digital printing technology, which is represented by an electrophotographic technology and an ink-jet technology, has been increasing its presence as an image-forming technology in offices and homes in recent years.

Among them, an ink-jet technology has striking characteristics of compactness and low power consumption as a direct recording method. In addition, the picture quality has been rapidly improved owing to a finer nozzle. One example of the ink-jet technology is a method of evaporating and foaming an ink supplied from an ink tank by heating it with a heater in a nozzle, and discharging the ink to form an image on a recording medium. Another example is a method of discharging the ink from the nozzle by vibrating a piezoelectric element.

Because in these methods an aqueous dye solution is usually used for ink, it might have caused bleeding or a phenomenon called feathering occurring along a fiber direction of a paper at recorded points on a recording medium, when colors have been superposed. For the-purpose of improving them, there are the cases of using a reaction of an anionic ink with a cationic ink (U.S. Pat. No. 5,555,008 and U.S. Pat. No. 5,801,733). However, the further improvements are demanded on weather resistance and rub fastness.

### DISCLOSURE OF THE INVENTION

The present invention is designed with respect to the related background arts, and is directed at providing a recording method which inhibits bleeding between the fixed parts of coloring materials from occurring when an image consisting of the fixed parts of the coloring materials is formed on a recording medium with the use-of an ink composition containing the coloring materials, can shorten a fixing period of time, and has superior fixability. The present invention is further directed at providing a set of ink compositions applicable to the recording method and an image-forming apparatus.

A recording method according to the present invention is characterized in that the method comprises the steps of: preparing a first ink composition containing a solvent, a coloring material and an anionic polymer, in which the coloring material is incorporated in the anionic polymer, and a second ink composition containing a solvent, a coloring material and a cationic polymer; and applying the first ink composition and the second ink composition onto a medium by bringing the compositions into contact with each other, and in that the contact increases the viscosity of at least one of the anionic polymer and the cationic polymer.

The anionic polymer and the cationic polymer can have a repeating structure of polyalkenyl ether.

According to the present invention, the anionic polymer of the first ink composition has a polyalkenyl ether structure, and the polyalkenyl ether structure can be expressed by the following general formula (1): 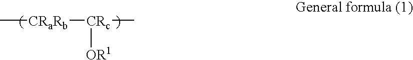
wherein Rₐ, R_{b} and R_{c} are independently H or CH₃; R¹ is selected from the group consisting of a linear, branched or cyclic alkyl group having 1 to 18 carbon atoms, —(CH(R²)—CH(R³)—O)₁—R⁴ and —(CH₂)ₘ—(O)ₙ—R⁴; 1 and m are independently selected from integers of 1 to 12; n is 0 or 1; R² and R³ are independently H or CH₃; R⁴ is selected from the group consisting of H, a linear, branched or cyclic alkyl group having 1 to 6 carbon atoms, -Ph, -Pyr, -Ph-Ph, -Ph-Pyr, —CHO, —CH₂CHO, —CO—CH═CH₂, —CO—C(CH₃)═CH₂, —CH₂COOR⁵ and -PhCOOR⁵, and when R⁴ is other than a hydrogen atom, a hydrogen atom on a carbon atom may be substituted with a linear or branched alkyl group having 1 to 4 carbon atoms; and R⁵ is H or a salt comprising Na or K.

According to the present invention, the cationic polymer of the second ink composition can have a polyalkenyl ether structure, and the polyalkenyl ether structure can be represented by the following general formula (2): 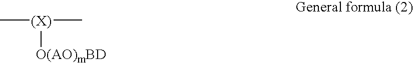
wherein X represents a polyalkenyl group; A represents a linear or branched alkylene group having 1 to 15 carbon atoms optionally substituted; m is an integer of 0 to 30, and when m is plural, A may be different; B represents a single bond or an optionally substituted alkylene group; and D represents an ammonium salt.

The coloring material in the first and second ink compositions can be pigment.

The coloring material in the second ink composition can be a dye.

The second ink composition can contain an organic ion and a dye.

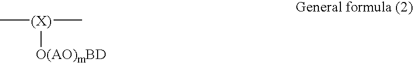

Furthermore, the present invention includes a set of inks comprising the first ink composition and the second ink composition applicable to the recording method according to the present invention.

Furthermore, the present invention includes an image-forming apparatus characterized in that the apparatus comprises ink-applying means exerting energy on each of the first ink composition and the second ink composition to apply the ink compositions to a medium and thereby form images, and driving means for driving the ink-applying means.

The present invention can provide a recording method which inhibits the occurrence of bleeding between the fixed parts of coloring materials from occurring when an image consisting of the fixed parts of the coloring materials is formed on a recording medium with the use of an ink composition containing the coloring materials, can shorten a fixing period of time and has adequate fixability. In addition, the present invention can provide a set of inks applicable to a recording method according to the present invention, and an image-forming apparatus which can inhibit the occurrence of bleeding between fixed parts of coloring materials.

### BRIEF DESCRIPTION OF THE DRAWINGS

FIG. 1 is a block diagram showing a configuration example of an ink-jet recording device.

### BEST MODE FOR CARRYING TO THE INVENTION

The present invention will be described in detail below.

A recording method according to the present invention is characterized in that the method comprises the steps of: preparing a first ink composition containing a solvent, a coloring material and an anionic polymer, in which the coloring material is incorporated in the anionic polymer, and a second ink composition containing a solvent, a coloring material and a cationic polymer; and applying the first ink composition and the second ink composition onto a medium by bringing the compositions into contact with each other, and in that the contact increases the viscosity of at least one of the anionic polymer and the cationic polymer.

Coloring materials contained in the first ink composition and the second ink composition are preferably two sorts of coloring materials with different colors or the same color. A polychrome recording with the use of the ink compositions containing the coloring materials with two different colors becomes possible through employing a method according to the present invention, or a monochrome recording with the use of the ink compositions using the coloring materials with two same colors. When they are applied, they are adequately fixed on a recording medium to form colored parts, and can adequately inhibit the occurrence of bleeding between the colored parts obtained from different ink compositions.

In the present invention, it is preferable that both of first and second ink compositions contain a solvent and a functional material, the first ink composition has a structure of making the functional material incorporated and dispersed in an anionic polymer having a polyalkenyl ether structure, the second ink composition contains a cationic polymer with a counter ion for the anionic polymer, and the recording method forms a polychrome record or a monochrome record on a recording medium through contacting the ink composition with each other.

A coloring material according to the present invention includes a granular solid material such as a pigment, and a dye compound.

An example of a coloring material is the pigment as described above, which includes an inorganic achromatic color pigment, an organic or inorganic chromatic color pigment, a colorless or light color pigment, and a metallic luster pigment. A newly synthesized pigment for the present invention may be used.

Commercially available pigments for black, cyan, magenta and yellow are exemplified in the following. A black pigment includes Raven1060 (a brand name, made by Colombian Carbon Co.), MOGUL-L (a brand name, made by Cabot Corp.), Color Black FW1 (a brand name, made by Degussa AG) and MA100 (a brand name, made by Mitsubishi Chemical Corp.), but is not limited thereto.

A cyan color pigment includes C. I. Pigment Blue-15:3, C. I. Pigment Blue-15:4 and C. I. Pigment Blue-16, but is not limited thereto.

A magenta color pigment includes C. I. Pigment Red-122, C. I. Pigment Red-123 and C. I. Pigment Red-146, but is not limited thereto.

A yellow pigment includes C. I. Pigment Yellow-74, C. I. Pigment Yellow-128 and C. I. Pigment Yellow-129, but is not limited thereto.

In addition, a dye as well as a pigment can be used in the present invention. A usable dye may be a well-known one or a new one. For instance, as will be described below, a water soluble dye such as a direct dye, an acid dye, a basic dye, a reactive dye and a food dye, a lipophilic (oil soluble) dye, and an insoluble coloring matter such as a disperse dye, can be used, and they may be used in a solidified state. In this respect, for instance, the oil soluble dye is preferably used.

For instance, a water soluble dye includes direct dyes such as C. I. Direct Black-17, -62 and -154; C. I. Direct Yellow-12, -87 and -142; C. I. Direct Red-1, -62 and -243; C. I. Direct Blue-6, -78 and -199; C. I. Direct Orange-34 and -60; C. I. Direct Violet-47 and -48; C. I. Direct brown-109; and C. I. Direct Green-59:

acid dyes such as C. I. Acid Black-2, -52 and -208; C. I. Acid Yellow-11, -29 and -71; C. I. Acid Red-1, -52 and -317; C. I. Acid Blue-9, -93 and -254; C. I. Acid Orange-7 and -19; and C. I. Acid Violet-49: reactive dyes such as C. I. Reactive Black-1, -23 and -39, C. I. Reactive Yellow-2, -77 and -163; C. I. Reactive Red-3, -111 and -221; C. I. Reactive Blue-2 -101 and -217; C. I. Reactive Orange-5, -74 and -99; C. I. Reactive Violet-1, -24 and -38; C. I. Reactive Green-5, -15 and -23; and C. I. Reactive brown-2, -18 and -33:

and C. I. Basic black-2; C. I. Basic Red-1, -12 and -27; C. I. Basic Blue-1 and -24; C. I. Basic Violet-7, -14 and -27; and C. I. Food Black-1 and -2.

Commercially available oil-soluble dyes for each color will now be explained with examples below.

A black oil-soluble dye includes C. I. Solvent Black-3,-22: 1, and -50, but is not limited thereto.

A yellow oil-soluble dye includes C. I. Solvent Yellow-1, -25: 1, and -172, but is not limited thereto.

An orange oil-soluble dye includes C. I. Solvent Orange-1, -40: 1, and -99, but is not limited thereto.

A red oil-soluble dye includes C. I. Solvent Red-1, -111, and -229, but is not limited thereto.

A violet oil-soluble dye includes C. I. Solvent Violet-2, -11, and -47, but is not limited thereto.

A blue oil-soluble dye includes C. I. Solvent Blue-2, -43, and -134, but is not limited thereto.

A green oil-soluble dye includes C. I. Solvent Green-1, -20, and -33, but is not limited thereto.

A brown oil-soluble dye includes C. I. Solvent Brown-1, -12 and -58, but is not limited thereto.

The examples of the above described coloring materials are particularly preferable for a liquid composition according to the present invention, but a coloring material used in the present invention is not particularly limited to the above described coloring materials.

The content of a coloring material is preferably in a range between 0.01 and 80% by weight with respect to the total weight of an ink composition. When using two or more coloring materials, the total weight thereof is preferably set to be in the range. When the quantity of the coloring material is 0.01% by weight or more, preferable color development is provided, and when it is 80% by weight or less, preferable dispersibility is provided. A preferable amount is in a range between 0.1% by weight and 50% by weight. A further preferable amount is in a range between 0.3% by weight and 30% by weight.

In addition, an ink composition used in the present invention contains a liquid medium. A liquid medium contained in the ink composition according to the present invention is not limited in particular, but means a liquid medium capable of dissolving, suspending or dispersing the components contained in the ink composition therein. A liquid medium usable in the present invention includes a water-insoluble organic solvent such as various linear, branched and cyclic aliphatic hydrocarbons, aromatic hydrocarbon and heteroaromatic hydrocarbon; a water-soluble organic solvent; water; and a mixed solvent thereof as a matter of course.

In the present invention, particularly, water or a liquid medium consisting of water and a water-soluble organic solvent can be preferably used.

The examples of a water-soluble organic solvent include polyvalent alcohols such as ethylene glycol, diethylene glycol, triethylene glycol, polyethylene glycol, propylene glycol, polypropylene glycol and glycerin; polyalcoholic ethers such as ethylene glycol monomethyl ether, ethylene glycol monoethyl ether, ethylene glycol monobutyl ether, diethylene glycol monoethyl ether and diethylene glycol monobutyl ether; and nitrogen-containing solvents such as N-methyl-2-pyrrolidone, substituted pyrrolidone and triethanolamine. In addition, monovalent alcohols such as methanol, ethanol and isopropyl alcohol can be used, and two or more of them can be used in combination as needed.

As for pH, a liquid medium can be used in all ranges of the pH, but preferable pH is in between 1 and 14. The content of a liquid medium used in a liquid composition according to the present invention can be selected from a range between 0.9% by weight and 99% by weight, and preferably is 10% by weight or more and 99% by weight or less. If the content is 0.9% by weight or more, the viscosity of an ink is not too high, and if it is 99% by weight or less, preferable color development is provided.

In addition, an anionic polymer used in a first ink composition according to the present invention is not limited in particular, but preferably is an anionic polymer having a polyalkenyl structure, and further preferably is a block polymer. A block polymer in the present invention means a copolymer obtained by covalently bonding different polymer units each consisting of a repeating unit structure, or equivalently, different block segments, and is also called a block copolymer. Further preferably, the above described block polymer is an amphiphilic polymer. Amphiphilic property means a property having both of a site having lyophilicity and a site having lyophobicity. For example, when a medium is water, an amphiphile forms a micelle particle, which can be observed.

Secondly, an anionic polymer is preferably a block polymer. The specific examples of a block polymer of a first ink composition usable in the present invention include conventionally known block polymers such as an acrylic and methacrylic block polymer, and an addition-polymerized or condensation-polymerized block polymer of polystyrene and another substance.

The block polymer of a first ink composition according to the present invention has more preferably a block form such as AB, ABA and ABC. A, B and C show different block segments from each other. In terms of forming an adequately incorporating state, an ABC block polymer is preferable, and more preferable is the ABC block polymer having hydrophobic, hydrophilic and hydrophilic block segments formed in order of A, B and C therein, and further preferable is the ABC block polymer having a nonionic and hydrophilic segment as B among the hydrophobic, hydrophilic and hydrophilic block segments, and an ionic and hydrophilic segment as C, and further preferably an anionic segment as C.

An anionic polymer used in a first ink composition according to the present invention is preferably a block polymer having a polyalkenyl ether structure, and particularly preferably, is a block polymer containing a polyvinyl ether structure. Methods for synthesizing a block polymer containing a polyalkenyl ether structure have been reported, but a representative one is a method by cationic living polymerization reported by Aoshima et al. (Polymer bulletin, vol. 15, 1986, p. 417, and Japanese Patent Laid-Open No. 11-322942). By synthesizing a polymer with the cationic living polymerization process, various polymers such as a homopolymer, a copolymer consisting of two or more components of monomers, and further a block polymer, a graft polymer and a graduation polymer, can be synthesized so as to have a precisely uniform length (molecular weight). In addition, the polyalkenyl ether can have various functional groups introduced into the side chain. The polymer can be also synthesized by a cationic polymerization process using a HI/I₂ or HCl/SnCl₄ system.

In addition, the structure of a block polymer containing a polyalkenyl ether structure may be a copolymer comprising a vinyl ether and another polymer. A preferably used one is a polymer formed of a polyvinyl ether repeated unit structure.

An anionic polymer used in a first ink composition according to the present invention is preferably has a repeated unit structure of a polyvinyl ether, and one example thereof is shown in the following general formula (1): 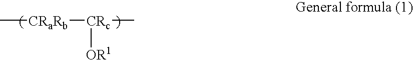
wherein Rₐ, R_{b} and R_{c} are independently H or CH₃; R¹ is selected from the group consisting of a linear, branched or cyclic alkyl group having 1 to 18 carbon atoms, —(CH(R²)—CH(R³)—O)₁—R⁴ and —(CH₂)ₘ—(O)ₙ—R⁴; I and m are independently selected from integers of 1 to 12; n is 0 or 1; R² and R³ are independently H or CH₃; R⁴ is selected from the group consisting of H, a linear, branched or cyclic alkyl group having 1 to 6 carbon atoms, -Ph, -Pyr, -Ph-Ph, -Ph-Pyr, —CHO, —CH₂CHO, —CO—CH═CH₂, —CO—C(CH₃)═CH₂, —CH₂COOR⁵ and -PhCOOR⁵, and when R⁴ is a substituent other than a hydrogen atom, a hydrogen atom on a carbon atom may be substituted with a linear or branched alkyl group having 1 to 4 carbon atoms; and R⁵ is H or a salt comprising Na or K.

Ph represents a phenyl group or a phenylene group and Pyr represents a pyridyl group.

The repeated unit structure shown in the above described general formula (1) is preferably used in each of A, B and C segments for an ABC triblock polymer preferably used in the present invention. A specific example of the usable repeated unit structure will be described below.

A repeated unit molecular structure of a hydrophobic polymer is specified below, but a polyvinyl ether structure used in the present invention is not limited thereto.

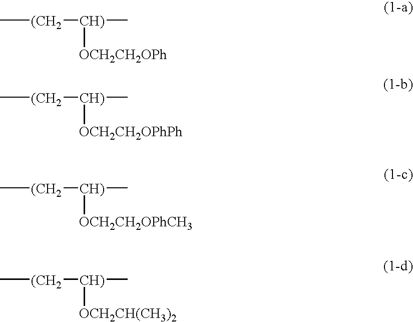

A repeated unit molecular structure of a thermal-stimulus responsive polymer is specified below, but a polyvinyl ether structure used in the present invention is not limited thereto. The responsiveness means that a hydrophilic group changes to a hydrophobic group by heating. For instance, in (I-f), the change appears at 21° C.

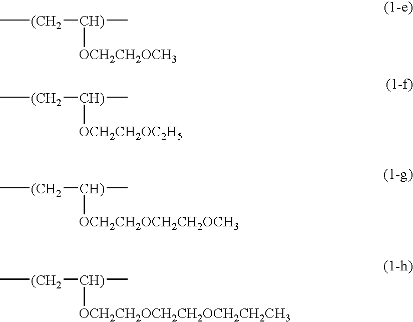

A repeated unit molecular structure of a hydrophilic polymer is specified below, but a polyvinyl ether structure used in the present invention is not limited thereto.

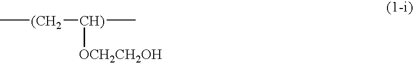

A repeated unit molecular structure of an anionic polymer is specified below, but a polyvinyl ether structure used in the present invention is not limited thereto. As the counter cation for each of them, there is NH₄⁺, Na⁺ or K⁺.

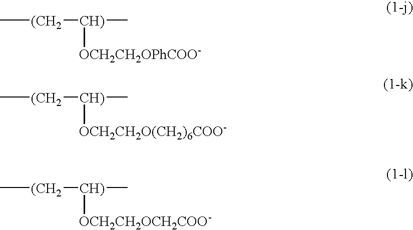

An amphipathic block polymer with the use of repeated unit structures of polyalkenyl ether though the structure is not limited to the above described examples, can be prepared, for instance, by selecting a hydrophobic block segment and a hydrophilic block segment and synthesizing them. In addition, in the case of a grafted polymer, an amphipathic polymer can be obtained by graft-bonding a hydrophobic polymer segment to a hydrophilic polymer. An anionic polymer contained in a first ink composition particularly preferably used in the present invention is an amphipathic block polymer.

An anionic polymer used in a first ink composition according to the present invention has preferably a molecular weight distribution, Mw (weight average molecular weight/Mn (number average molecular weight) of 2.0 or less. The molecular weight distribution is further preferably 1.6 or less, more preferably 1.3 or less, and still more preferably 1.2 or less.

A number average molecular weight Mn of an anionic polymer used in the present invention is 2,000 or more and preferably is 3,000 or more, but is better to be less than 1,000,000. When the number average molecular weight is less than 2,000, the dispersion stability of a functional material may not be adequate. The number average molecular weight and the weight average molecular weight of a polymer according to the present invention can be measured with size exclusion chromatography (sometimes called a gel permeation chromatography/GPC).

The content of anionic polymers used in a first ink composition according to the present invention is 0.1% by weight or more and 90% by weight or less of the ink composition, and preferably is 1% by weight—to 50% by weight. When the content is 0.1% by weight or more, the dispersed or dissolved state of the functional material in the ink composition is sufficient, and a 90% by weight or less content is preferable because viscosity becomes not too high.

A functional material contained in a first ink composition according to the present invention is preferably incorporated in a polymer so as not to be denatured by effects from an outer environment.

Modification described here may be physical denaturation, chemical modification or both. One example is a change (modification) in the dissociation degree of ions contained at least one of the above described cationic polymer and the above described anionic polymer, which occurs when the above described first and second ink compositions are contacted. Another example is a change (modification) in the solubility of at least one of the above described cationic polymer and the above described anionic polymer, which occurs when the above described two ink compositions are contacted. The modification is further preferably the change of viscosity in at least one of an ink composition, and the denaturation of thickening or gelation is one preferable pattern.

A functional material can be easily incorporated by particularly using an amphipathic block polymer because of forming a self-assembled structure. In order to improve dispersion stability and wrapping properties of a block polymer, the block polymer has preferably more flexible molecular motion because of easily physically entangling the functional material and having affinity for it. Furthermore, in terms of easily forming a coating layer on a recording medium, the block polymer with flexible molecular motion is preferable. For the purpose, the block polymer has a glass transition temperature Tg in a main chain of preferably 20° C. or lower, more preferably 0° C. or lower, and further preferably −20° C. or lower. In this respect, the polymer having a polyvinyl ether structure is preferably used because of having a low glass transition point and flexible characteristics.

A first ink composition according to the present invention has, as described above, preferably a form of wrapping a coloring material. The incorporated state can be formed, for instance, by adding a water-insoluble organic solvent containing the coloring material dissolved therein to a micelle formed of the block polymer in water and then distilling off the organic solvent. The incorporated state can also be formed by another method of phase-inverting a uniformly dispersed or co-dissolved state of a block polymer and a coloring material in an organic solvent into a dispersed state in a water-based solvent, and thereby making them self-assembled. A remaining solvent can be distilled off. The incorporated state can also be formed by further another method of, for instance, adding a water-insoluble organic solvent containing a pigment dispersed therein to a micelle formed of the block polymer in water.

A incorporated state can be confirmed by instrumental analysis with the use of various electron microscopes and an X-ray diffractometer. In addition, when a coloring material is incorporated into a micelle state, the incorporated state can be indirectly confirmed by individually separating the coloring material and a polymer from a solvent, through creating a disintegration condition for the micelle.

As has been described above, a block polymer preferably forms a micelle state, and for the purpose, an amphipathic block polymer is effectively used in the present invention. In this respect, a block polymer has further preferably a polymer segment with an anionic repeated unit structure. The block polymer has preferably the anionic repeated unit structure in terms of the necessity described below, and for the purpose of-forming a wrapping state as well. In the present invention, the block polymer is preferably used in terms of the characteristics such as dispersion stability, wrappability for the coloring material and viscosity.

In the next place, a second ink composition according to the present invention will be described. The second ink composition is an ink composition containing counter ions to the above described first ink composition. Because the first ink composition is an anionic liquid composition, the second ink composition is a cationic liquid composition. As a method of imparting cationic properties to the ink composition, there is a method of adding a compound showing basicity. One example is a method of adding an organic compound like a compound having an amino group (—NH₂) such as ammonia and an alkylamine, or a compound having a guanidino group and a biguanido group such as arginine and guanidine and biguanide derivatives containing more nitrogen atoms. The cationic polymer is, though the compound is not particularly limited thereto, preferably added to a second ink composition from the viewpoint of rub fastness of a second ink after the ink composition has been used for polychrome recording.

A cationic polymer is not limited in particular, but includes a polymer having an amino group or an imino group in a side chain or a main chain, like a synthetic polymer such as polyethyleneimine, polyvinylamine and polyallylamine and polyamino acid such as polyornithine and polylysine. Both of them are usually used in the form of an acid salt such as hydrochloride, because they are a water-soluble polymer and show basicity in water. A cationic polymer particularly used in a second ink composition according to the present invention is usefully a polymer having a polyalkenyl ether structure which has a low Tg and is water-soluble from the viewpoint of fixability and dispersion stability, and particularly preferably is a polymer having a structure represented by the following general formula (2): 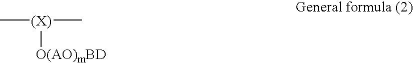
wherein X represents a polyalkenyl group; A represents a linear or branched alkylene group having 1 to 15 carbon atoms optionally substituted; m is an integer of 0 to 30, and when m is plural, A may be different; B represents a single bond or an optionally substituted alkylene group; and D represents an ammonium salt.

An ammonium salt means an acid salt of, for instance, a pyridyl group, a pyridyl phenyl group, an aromatic ring with at least one amino group substituting for a hydrogen atom, or an amino group. Here, an acid salt means, for instance, (—NH⁺₃Cl⁻) for an acid salt of an amino group (—NH₂) with hydrochloric acid, and (-PyrH⁺Cl⁻) for an acid salt of a pyridyl group (-Pyr) with hydrochloric acid.

Specific examples of a usable repeated unit structure are described below. A counter anion for them includes Br⁻ and Cl⁻.

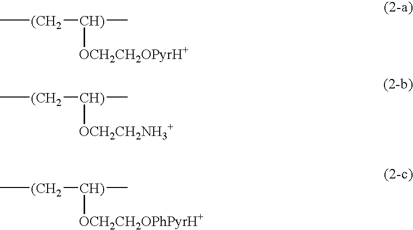

A cationic polymer in a second ink composition used in the present invention has preferably a molecular weight distribution, Mw (weight average molecular weight)/Mn (number average molecular weight) of 2.0 or less, more preferably is 1.6 or less, further preferably is 1.3 or less, and still further preferably 1.2 or less.

The cationic polymer in a second ink composition used in the present invention has a number average molecular weight Mn of 2,000 or more and preferably of 3,000 or more but less than 1,000,000. When the number average molecular weight is less than 200, a reactivity of two liquids in contact with each other may not be preferable. The number average molecular weight and the weight average molecular weight of a polymer according to the present invention can be measured with size exclusion chromatography (sometimes called a gel permeation chromatography/GPC).

The content of a cationic polymer used in a second ink composition according to the present invention is 0.1% by weight or more and 90% by weight or less of the ink composition, and preferably is 1% by weight or more and 50% by weight or less. When the content is 0.1% by weight or more, the cationic polymer gives preferable reactivity with a first ink composition, and a 90% by weight or less content is preferable because the viscosity becomes not too high.

A cationic polymer contained in a second ink composition according to the present invention has a glass transition temperature Tg of a main chain of preferably 20° C. or lower, more preferably 0° C. or lower, and further preferably −20° C. or lower. In this respect, the polymer having a polyvinyl ether structure is preferably used because of having a low glass transition point and flexible characteristics.

A coloring material in a second ink composition according to the present is preferably a self-dispersion pigment. The representative example is the self-dispersive pigment which is surface treated as is seen on carbon black. The example includes Aqua-Black R162 or Aqua-Black R001 (made by Tokai Carbon Co. Ltd.).

In addition, the coloring material of a second ink composition in the present invention preferably is a dye containing counter ions to a block polymer in a first ink composition, and particularly preferably a dye containing cations when the block polymer in the first ink composition is anionic. The cationic dye includes a triphenyl methane dye of a malachite green type, a pararosaniline type and an olin type, methylene blue (an amino hydrochloride type), Aizen Cathilon Red 6BH, Aizen Cathilon Blue K-2GLH and Aizen Cathilon Brilliant Yellow 5GLH.

Furthermore, as another case for a first ink composition containing an anionic block polymer, the second ink preferably employs a cationic organic ion and a dye. The cationic organic ion includes a cation of an organic compound having an amino group and derivative thereof (an amine salt, a quaternary amine salt or the like).

In addition, an ink composition applied to the present invention can contain additives in addition to the above described compound, such as an oxidation inhibitor, an agent for decreasing viscosity, an ultraviolet absorbing agent, a surface active agent and a fungicide.

The present invention also includes a recording method of forming a polychrome record or a monochrome record on a recording medium by using a first ink composition and a second ink composition both of which contain a solvent and a coloring material, while making the first ink composition contain an anionic polymer which incorporates a chromatic coloring material dispersed therein and the second ink composition contain cations of counter ions to the above described anionic polymer, and contacting the ink compositions with each other. In a first ink composition, the chromatic coloring materials are preferably incorporated and dispersed in an anionic polymer having a polyalkenyl ether structure.

In the present invention, two coloring materials contained each in a first ink composition and a second ink composition may have each different color or the same color, and when they are recorded on a recording medium, the former can form a polychrome record, and the latter forms a monochrome record.

In the present invention, at least one ink composition forms a polar pair with the other ink composition, so that typically when the two ink compositions are contacted on a recording medium, their ionic properties are changed. The change of ionic properties includes the change of pH, solubility or viscosity. As a result, the change enables an imaging method of inhibiting bleeding between the two ink compositions and increasing a drying speed. The changes is further preferably a denaturation of a polymer due to a reaction occurring when two liquids contact each other.

An example of such a case will be now further specifically described. Suppose that a first ink composition is a water dispersion ink which contains a micelle formed of an amphipathic anionic triblock polymer, the micelle with a yellow pigment incorporated therein, in which the block polymer has a hydrophilic part consisting of a nonionic hydrophilic block and an anionic hydrophilic block that is a sodium salt of a carboxylic acid having a pH adjusted to 9. Furthermore, suppose that a second ink composition is a water dispersion ink which contains a water-soluble cationic polymer having hydrochlorides of pyridine in a side chain, and a black self-dispersion pigment, and has pH adjusted to 2. When the first ink and the second ink are recorded on adjacent points with an ink jet method and the liquids contact, the first ink causes a change of the pH to an acid side, the neutralization of a sodium carboxylate in a hydrophilic group and strong interaction among micelle particles, and is thickened. In an extreme case, particles are aggregated. As a result, the first ink increases the viscosity and consequently decreases bleeding, or equivalently, mingling of colors. In this case, the first ink can form a micelle and cover a coloring material with it. As a result, the first ink reduces the chances for the coloring material to directly contact with air, and consequently works as a protective layer for the coloring material. The specific effect includes an improvement of rub fastness. Further expected effects are, when a pigment is used as a coloring material, excellent fixability onto a recording medium, particularly paper, and excellent resistance to water are expected, because the polymer has a polyalkenyl structure having a comparatively low glass transition temperature.

As described above, a preferable form according to the present invention is the thickening of at least one of a first ink composition and a second ink composition occurring when the ink compositions contact. Here, the contact of the first ink composition and the second ink composition means the contact of liquid surfaces of the first and second ink compositions, or the contact of the two ink compositions of the swollen state on a recording medium, and does not mean the contact of the two ink compositions by mechanically mixing them after having charged them altogether in a vessel. It means, for instance, the following case in which the two ink compositions are simultaneously discharged by recording through an ink-jet method, the liquid surfaces contact, each ink composition migrates to the other inner part through the contacting interface to cause the change of pH and consequent strong interaction, pigment-wrapping dispersions more strongly interact, and the liquid compositions are thickened.

In the next place, an ink-jet recording device suitable for carrying out a method according to the present invention will be described. The method according to the present invention can be applied to various ink-jet recording devices such as a piezoink jet type with the use of a piezoelectric element, and a bubble jet (a registered trademark) type of applying heat energy on ink to cause a film boiling phenomenon to record images.

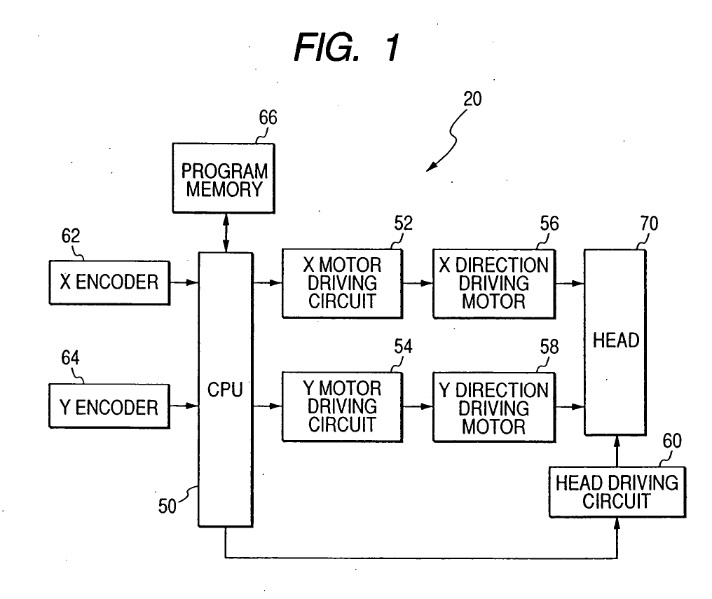

An outline of the ink-jet recording device will be described below with reference to FIG. 1. However, FIG. 1 is one example of configuration and does not limit the present invention.

FIG. 1 is a block diagram showing the configuration of an ink-jet recording device.

FIG. 1 shows the case of moving a head to record images on a medium to be recorded. In FIG. 1, an X-direction driving motor 56 and a Y-direction driving motor 58 for driving a head 70 to X and Y directions are connected to a CPU 50 for controlling the total operation of a manufacturing apparatus through an X motor driving circuit 52 and a Y motor driving circuit 54. According to the direction of the CPU through the X motor driving circuit 52 and the Y motor driving circuit 54, the X-direction driving motor 56 and the Y-direction driving motor 58 work, and determine a position of the head 70 with respect to the medium to be recorded.

As shown in FIG. 1, a head driving circuit 60 in addition to the X-direction driving motor 56 and the Y-direction driving motor 58 is connected to the head 70, and the CPU 50 controls the head driving circuit 60 and drives the head 70, or equivalently, discharges ink for being jetted. In addition, an X encoder 62 and a Y encoder 64 for detecting the position of the head are connected to the CPU 50, and the position information of the head 70 is input into them. In addition, a control program is also input into a program memory 66. The CPU 50 moves the head 70 on the basis of the control program and the position information in the X encoder 62 and the Y encoder 64, and arranges the head at a desired position on the medium to be recorded, and makes the head discharge the ink for being jetted. Thus, desired drawing can be formed on the medium to be recorded. In addition, in the case of an image-recording device capable of accommodating a plurality of ink for being jetted, desired drawing can be formed on the medium to-be recorded by carrying out a predetermined number of the above described operations for the ink for being jetted.

In addition, the image-recording device can move the head 70 to the position where removing means (not shown) for removing surplus ink attaching to the head is arranged, after the head has discharged the ink for being jetted, as needed, and make the ink-removing means wipe the head 70 to clean it. A conventional method can be specifically used for cleaning without being changed.

After drawing has been finished, the recorded medium is replaced with a new medium to be recorded by a mechanism for transporting a medium to be recorded which is not shown.

In addition, in the present invention, the above described embodiment can be revised or transformed without departing from the scope of the invention. For instance, the above description has shown an example in which the head 70 moves in X-axis and Y-axis directions, but another type may be employed in which the head 70 moves only in an X-axis direction (or a Y-axis direction), and a medium to be recorded moves in the Y-axis direction (or the X-axis direction), and these motions make drawing while interlocking with each other.

An image-forming apparatus in the present invention comprises means for generating heat energy (for instance, an electrothermal conversion element or a laser beam) as the energy used for discharging ink for being jetted, and a head for discharging the ink for being jetted by the above described heat energy as an effective head. By using the above described type of the image-forming apparatus, the high definition of drawing can be formed. By using the ink according to the present invention, further excellent drawing can be formed.

The representative configuration and principle of a preferable device having the means for generating the above described heat energy are disclosed, for instance, in U.S. Pat. No. 4,723,129 and U.S. Pat. No. 4,740,796. A method based on the principle can be applied to both of a so-called on-demand type and continuous type, but can be particularly effectively applied to the on-demand type. Because the on-demand type retains a liquid, applies at least one driving signal for rapidly raising the temperature of the liquid into the temperature exceeding nucleate boiling while corresponding to discharge information to an electrothermal conversion element arranged in correspondence with a channel to generate heat energy in the electrothermal conversion element, makes an exothermic plane cause the film boiling of the liquid thereon, and consequently forms air bubbles in the liquid so as to make one-to-one correspondence with the driving signal. The method discharges a liquid by the growth and shrinkage of the air bubbles through an opening for discharge, and forms at least one drop. If the driving signal has a pulse shape, the signal immediately grows or shrinks the air bubbles appropriately, so that the image-forming apparatus further preferably discharges a liquid while adequately responding to the signal. As for the driving signal having the pulse shape, such driving signals as being described in U.S. Pat. No. 4,463,359 and U.S. Pat. No. 4,345,262 are suitable. In addition, further superior discharge can be performed by adopting conditions described in U.S. Pat. No. 4,313,124 of the invention according to the heat rate of the above described exothermic plane.

As for a configuration of a head, the present invention includes the configuration in which an exothermic portion is placed in an inflection region, as is disclosed in U.S. Pat. No. 4,558,333 and U.S. Pat. No. 4,459,600, in addition to the configuration combining a discharge opening, a liquid channel, and an electrothermal conversion element (straight liquid channel or right angle liquid channel) as is disclosed in the above described specification. In addition, the present invention shows significant effect even in the case of employing the configuration of arranging a common slit to a plurality of electrothermal conversion elements and using it for the discharge portion of the electrothermal conversion elements, which is disclosed in Japanese Patent Laid-Open No. S59-.123670, or the configuration based on Japanese Patent Laid-Open No. S59-138461 which discloses the configuration of using an opening for absorbing the pressure wave of heat energy as the discharge portion.

Specifically, an image-forming apparatus according the present invention can reliably and efficiently discharge ink for being jetted, regardless of the shape of a head.

Furthermore, an image-forming apparatus according to the present invention can be effectively applied to a full-line-type head having a length corresponding to the maximum width of a medium to be recorded. Such a head may have the configuration of satisfying the length by combining a plurality of heads or the configuration comprising one integrally-formed head.

In addition, an image-forming apparatus according to the present invention is effective in the case of using a serial type of a head, a fixed head in the main body of an apparatus, or an exchangeable chip-type head which can be electrically connected to the main body of an apparatus or can receive ink from the main body of an apparatus because of being mounted on the main body-of an apparatus.

Furthermore, an apparatus according to the present invention may further have a droplet-removing means. If the apparatus is provided with such means, it can realize a further excellent discharge effect.

In addition, if an apparatus according to the present invention has a configuration provided with auxiliary means, it preferably further stabilizes the effect of the present invention. The specific auxiliary means includes capping means to a head, pressurizing or absorbing means, an electrothermal conversion element, another heating element, preliminary heating means for heating with the use of the combination thereof, and preliminary discharging means for discharging a different material from ink.

The most effective type of the image-forming apparatus according to the present invention is the above described film boiling type.

In an apparatus according to the present invention, the amount of ink discharged from each discharge opening of a discharge head for discharging ink for being jetted is preferably in the range between 0.1 picoliters and 100 picoliters.

In addition, ink as a liquid composition according to the present invention can be also applied to an indirect recording device which employs a recording system of printing ink on an intermediate transfer member and then copying it onto a recording medium such as paper. It is also applicable to an apparatus using an intermediate transfer member by a direct recording method.

### EXAMPLE

Referring to embodiments, the present invention will be described in detail below, but the present invention is not limited to the embodiments.

### Synthesis Example 1 (Synthesis of Polymer)

(1) Synthesis of triblock polymer comprising isobutyl vinyl ether, 2-(4-biphenyloxy)ethyl vinyl ether (a block component A), 2-(2-methoxyethoxy)ethyl vinyl ether (a block component B) and sodium 4-(2-vinyloxyethoxy)benzoate (a block component C)

In a glass vessel provided with a three-way stopcock, air was substituted with nitrogen gas, and the glass vessel was heated to 250° C. in a nitrogen gas atmosphere to remove adsorped water. The system was returned to a room temperature, then 20 mmol (millimole) of isobutyl vinyl ether (IBVE), 20 mmol of 2-(4-biphenyloxy)-ethyl-vinyl ether (BPhOVE), 16 mmol of ethyl acetate, 0.1 mmol of 1-isobutoxyethyl acetate and 11 ml of toluene were added to the system, and the reaction system was cooled. When the temperature in the system reached 0° C., 0.2 mmol of ethyl aluminium sesquichloride (the equimolar mixture of diethyl aluminium chloride and ethyl aluminum dichloride) was added to start the polymerization. The molecular weight was monitored on every divided time with the use of a molecular-sieve column chromatography (GPC), to confirm the completion of the polymerization of a component A.

Subsequently, 44 mmol of 2-(2-methoxyethoxy)-ethyl vinyl ether (MOEOVE) was added to start the polymerization of a segment B. The molecular weight was monitored on every divided time with the use of a molecular-sieve column chromatography (GPC), to confirm the completion of the polymerization of the component B.

Finally, a toluene solution of 10 mmol of a block component C was added to continue polymerization. After 16 hours, polymerization reaction was stopped. The polymerization reaction was stopped by adding 0.3% by weight of an ammonia/methanol aqueous solution into the system. A reacted mixture solution was diluted with dichloromethane, and the product was washed with 0.6 M hydrochloric acid for three times and subsequently with distilled water for three times. The obtained organic phase was concentrated and exsiccated with an evaporator, the product was vacuum-dried and repeatedly dialyzed in a methanol solvent by using a semi-permeable membrane of cellulose to remove monomer compounds, and a triblock polymer was obtained.

The obtained polymer compound was identified with the use of NMR and GPC (polymerization ratio A/B/C=100/116/9, number average molecular weight of 25,300, weight average molecular weight of 30,800). The obtained block polymer in the amount of 26 parts by weight was mixed and stirred with 200 parts by weight of a sodium hydroxide solution with a pH of 13 at 0° C. for three days, to convert itself to a polymer solution of sodium carboxylate. The solution was dialyzed to remove excess of sodium hydroxide and was dried, and a solvent was distilled off to isolate a sodium salt of a carbonic acid type ABC block polymer.

(2) Synthesis of polymerizable compound (CH₂═CHOCH₂CH₂O—(4-(2,6-dimethyl)pyridine))

To dimethylformamide of 11 L, 11.34 mole of 2,6-dimethyl-4-hydroxypyridine was dissolved, and 25.52 mole of calcium carbonate was added.

Into the liquid, 12.47 mol of 2-chloroethyl vinyl ether was added, and the resultant liquid was heated, was stirred at 100 to 110° C. for 10 hours, was cooled to a room temperature, and was poured into 33 L of iced water.

The solute was extracted with toluene, and an organic layer was washed with the saturated salt solution, was dehydrated with magnesium sulfate, and then was concentrated. The product was purified through silica gel column chromatography, was decolorized with activated carbon and was then distilled under a reduced pressure, and 2,6-dimethyl-4-hydroxypyridine was obtained (with a yield of 15.6%).

(3) Synthesis of polymer formed of CH₂═CHOCH₂CH₂O—(4-(2,6-dimethyl)pyridine)

A compound CH₂═CHOCH₂CH₂O—(4-(2,6-dimethyl)pyridine) in the amount of 100 mmol, 2 mmol of water and 5 mmol of ethyl aluminum dichloride were polymerized in anhydrous toluene with a cationic polymerization process.

The reaction was ended after 20 hours, methylene chloride and water were added to the liquid, and the product was washed with water, a dilute hydrochloric acid solution and an alkaline solution, and then was dried with anhydrous sodium sulfate, and a solvent was distilled off to obtain a high molecular compound (a polymer). The number average molecular weight measured with excluded volume chromatography was 3,000. Synthesis was carried out in the same manner as above. The polymer in the amount of 26 parts by weight was suspended in methylene chloride, and 200 parts by weight of a hydrochloric acid solution with a pH of 2 was added to the liquid, and the product was stirred at 0° C. for three days and was shaken and mixed in a liquid-separating funnel. The obtained organic layer was washed with water for several times, then concentrated and exsiccated, and a hydrochloride type polymer was isolated.

Example of Preparing Ink (Preparation of Ink)

(1) A first ink: 3 parts by weight of a magenta pigment, C. I. Pigment Red 122, 5 parts by weight of a block polymer in the synthesis example (1), and 15 parts by weight of diethylene glycol were added to 178 parts by weight of ion-exchanged water, and the pH of the liquid was adjusted to 7.8, and the solute was dispersed with the use of an ultrasonic homogenizer. A pigment dispersed water-color ink was prepared by pressure-filtrating the above described dispersion through a filter of 1 μm. The ink showed adequate dispersibility of the pigment.

When each of the above described liquid compositions was frozen with a cryo-TEM provided with an energy filter and was observed with an electron microscope, only spherical micelle particles were observed, which meant that a coloring material was completely incorporated in a block polymer.

(2) A second ink A: 3 parts by weight of black pigment (a brand name of MOGUL-L, made by Cabot Corp.), 5 parts by weight of a polymer in a synthesis example (3) and 15 parts by weight of diethylene glycol were added to 178 parts by weight of ion-exchanged water, and the pH of the liquid was adjusted to 4.5, and the solute was dispersed with the use of an ultrasonic homogenizer. A pigment dispersed water-color ink was prepared by pressure-filtrating the above described dispersion through a filter of 1 μm. The ink showed adequate dispersibility of the pigment.

(3) A second ink B: 3 parts by weight of methylene blue (hydrochloride type) of a basic dye, 15 parts by weight of diethylene glycol were added into 178 parts by-weight of ion-exchanged water containing hydrochloric acid, and the solute was uniformly dissolved with the use of an ultrasonic homogenizer. An acidic aqueous dye ink was prepared by pressure-filtrating the above described solution through a filter of 1 μm.

(4) A second ink C: 3 parts by weight of a blue dye (C. I. Direct Blue-6), 5 parts by weight of dimethylamine hydrochloride and 15 parts by weight of diethylene glycol were added to 178 parts by weight of ion-exchanged water, and the solute was uniformly dissolved with the use of an ultrasonic homogenizer. A pigment dispersed water-color ink was prepared by pressure-filtrating the above described solution through a filter of 1 μm. The ink showed adequate dispersibility of the pigment.

### Example 1 Print Evaluation

A record was made with an ink-jet method by using the above described first ink and second ink A. The two ink compositions were filled in the ink tank of an ink-jet printer (a brand name BJF800, a Bubble-Jet printer (registered trademark) made by Canon Inc.), and alternate patterns of black and magenta were recorded on plain paper at the spacing of 1 mm, the bleeding in a boundary between black and magenta was hardly recognized. When the recorded paper was observed with a microscope, the pattern showed bleeding with the average width of 0.18 mm. When a recording part was pushed with a finger after 30 seconds of printing, the ink was not transferred to the finger.

In addition, when an area of about 50 cm² of the paper was moistened with distilled water of 10 ml just after printing, the recorded pattern did not change.

### Example 2

A record was made with an ink-jet method by using the above described first ink and second ink B in the same manner as in Example 1. When the alternate pattern of two colors was recorded on plain paper at the spacing of 1 mm, the bleeding in a boundary between the two colors was hardly observed. When the recorded paper was observed with a microscope, the pattern showed bleeding with the average width of 0.21 mm. When a recording part was pushed with a finger after 30 seconds of printing, the ink was not transferred to the finger.

In addition, when an area of about 50 cm² of the paper was moistened with distilled water of 10 ml just after printing, the recorded pattern did not change.

### Example 3

A record was made with an ink-jet method by using the above described first ink and second ink C in the same manner as in Example 1. When the alternate pattern of two colors was recorded on plain paper at the spacing of 1 mm, the bleeding in a boundary between the two colors was hardly observed. When the recorded paper was observed with a microscope, the pattern showed bleeding with the average width of 0.23 mm. When a recording part was pushed with a finger after 30 seconds of printing, the ink was not transferred to the finger.

In addition, when an area of about 50 cm² of the paper was moistened with distilled water of 10 ml just after printing, the recorded pattern did not change.

### Comparative Example 1

When a printing test was conducted in the same manner as in Example 1 with the use of the black ink (the first ink) used in the above described example 1, and a magenta ink (a second ink) equipped in BJF800, bleeding was clearly recognized in a boundary between black and magenta with visual observation. When the recorded paper was observed with a microscope, the pattern showed bleeding with the average width of 0.36 mm. When a recording part was pushed with a finger after 30 seconds of printing, the ink was transferred to the finger.

In addition, when an area of about 50 cm² of the paper was moistened with distilled water of 10 ml just after printing, the bleeding and mixture of the colors simultaneously occurred and the recorded pattern showed a great change.

### Comparative Example 2

Preparation of First Ink

A magenta pigment, C. I. Pigment Red 122 in the amount of 3 parts by weight, 5 parts by weight of a block polymer of sodium styrene acrylate (an one-to-one copolymer with a number average molecular weight of 6,300 and a weight average molecular weight of 9,200) and 15 parts by weight of diethylene glycol were added to 178 parts by weight of ion-exchanged water, and further the pH of the liquid was adjusted to 9.7, and the solute was dispersed with the use of an ultrasonic homogenizer. A pigment dispersed water-color ink was prepared by pressure-filtrating the above described dispersion through a filter of 1 μm. The ink showed adequate dispersibility of the pigment.

Preparation of Second Ink

A black pigment (brand name MOGUL-L, product made in Cabot Corp.) in the amount of 3 parts by weight, 5 parts by weight of a random copolymer of sodium styrene sulfonate and styrene (an one-to-two copolymer with a number average molecular weight of 4,500 and-a weight average molecular weight of 7,900) and 15 parts by weight of diethylene glycol were added to 178 parts by weight of ion-exchanged water, and further the pH of the liquid was adjusted to 6.1, and the solute was dispersed with the use of an ultrasonic homogenizer. A pigment dispersed water-color ink was prepared by pressure-filtrating the above described dispersion through a filter of 1 μm. The ink showed adequate dispersibility of the pigment.

When an alternate pattern was recorded on a plain paper at the spacing of 1 mm by using a first and second ink in the same manner as in Example 1, bleeding in a boundary was recognized with visual observation, and the average width of the bleeding observed with a microscope was 0.38 mm.

In addition, when an area of about 50 cm² of the paper was moistened with distilled water of 10 ml just after printing, the bleeding and mixture of the colors simultaneously occurred and the recorded pattern showed a great change.

This application claims priority from Japanese Patent Application Nos. 2004-139194 filed May 7, 2004 and 2004-376606 filed on Dec. 27, 2004, which are hereby incorporated by reference herein.

1. A recording method characterized in that the method comprises the steps of: preparing a first ink composition containing a solvent, a coloring material and an anionic polymer, in which the coloring material is incorporated in the anionic polymer, and a second ink composition containing a solvent, a coloring material and a cationic polymer; and applying the first ink composition and the second ink composition onto a medium by bringing the compositions into contact with each other, and in that the contact increases the viscosity of at least one of the anionic polymer and the cationic polymer.

2. The recording method according to claim 1, characterized in that the anionic polymer and the cationic polymer have a repeating structure of polyalkenyl ether.

3. The recording method according to claim 2, characterized in that the anionic polymer of the first ink composition has a polyalkenyl ether structure, and the polyalkenyl ether structure is represented by the following general formula (1): 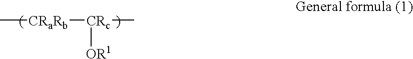
wherein Rₐ, R_{b} and R_{c} are independently H or CH₃; R¹ is selected from the group consisting of a linear, branched or cyclic alkyl group having 1 to 18 carbon atoms, —(CH(R₂)—CH(R³)—O)ₗ—R⁴ and —(CH₂)ₘ—(O)ₙ—R⁴; 1 and m are independently selected from integers of 1 to 12; n is 0 or 1; each of R² and R³ is independently H or CH₃; R⁴ is selected from the group consisting of H, a linear, branched or cyclic alkyl group having 1 to 6 carbon atoms, -Ph, -Pyr, -Ph-Ph, -Ph-Pyr, —CHO, —CH₂CHO, —CO—CH═CH₂, —CO—C(CH₃)═CH₂, —CH₂COOR⁵ and -PhCOOR⁵, and when R⁴ is other than a hydrogen atom, a hydrogen atom on a carbon atom may be substituted with a linear or branched alkyl group having 1 to 4 carbon atoms; and R⁵ is H or a salt comprising Na or K.

4. The recording method according to claim 2, characterized in that the cationic polymer of the second ink composition has a polyalkenyl ether structure, and the polyalkenyl ether structure is represented by the following general formula (2): 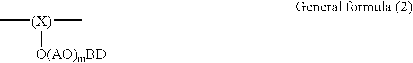
wherein X represents a polyalkenyl group; A represents a linear or branched alkylene group having 1 to 15 carbon atoms optionally substituted; m is an integer of 0 to 30, and when m is plural, A may be different; B represents a single bond or an optionally substituted alkylene group; and D represents an ammonium salt.

5. The recording method according to any one of claims 1 to 4, characterized in that the coloring material in the first ink composition and the second ink composition is a pigment.

6. The recording method according to any one of claims 1 to 4, characterized in that the coloring material in the second ink composition is a dye.

7. The recording method according to claim 6, characterized in that the second ink composition contains an organic ion and a dye.

8. A set of inks comprising the first ink composition and the second ink composition according to any one of claims 1 to 4.

9. An image-forming apparatus characterized in that the apparatus comprises ink-applying means for exerting energy on each of the first ink composition and the second ink composition according to any one of claims 1 to 4 to apply the ink compositions to a medium and thereby form images, and driving means for driving the ink-applying means.
